(19) United States
(12) Patent Application Publication
(10) Pub. No.: US 2015/0075448 A1
(43) Pub. Date: Mar. 19, 2015

(54) HANDS FREE DOG WALKING GEAR

(71) Applicant: Freedom Dogs, LLC, St. Louis, MO (US)

(72) Inventors: Colleen P. Clark, Hollywood, FL (US); Jeffrey S. Brooks, St. Louis, MO (US)

(21) Appl. No.: 14/333,499

(22) Filed: Jul. 16, 2014

Related U.S. Application Data
(60) Provisional application No. 61/846,707, filed on Jul. 16, 2013.

(51) Int. Cl. A01K 27/00

(52) U.S. Cl. CPC A01K 27/003; A01K 27/008
USPC 119/797; 119/795

(57) ABSTRACT

Apparatus for leading an animal. The apparatus includes a belt sized for encircling a user's hips. The belt has a closure for selectively joining longitudinally spaced portions of the belt to hold the belt in position around the user's hips with an upper edge. The apparatus includes an anchor connected to the belt adjacent the upper edge. The anchor spans a predetermined longitudinal distance along the belt. The apparatus includes a connector slidably mounted on the anchor for connecting an animal lead to the belt such that an upper end of the lead is selectively positionable along the anchor for guiding the animal circumferentially relative to the user while restraining the animal.

### CROSS REFERENCE TO RELATED APPLICATION

This application claims priority to U.S. Provisional Patent Application 61/846,707 filed on Jul. 16, 2013, which is hereby incorporated by reference in its entirety.

### BACKGROUND

The present invention generally relates to an animal lead, and more particularly, to apparatus allowing a user to lead an animal, such as a dog or exotic animal, or even a child, without holding a leash.

Pet owners frequently walk or run with animals on a handheld leash. Such leashes have a loop at an upper end, which is held in a user's hand. The lower end of the leash is connected to the animal. Thus, a user must hold the leash when leading the animal. If the animal pulls, the user must grasp the leash tighter, causing strain on the hand, arm, shoulder, and back. Further, pet owners frequently carry animal waste recovery bags for cleaning up after their pets, as well as cell phones and other devices. There is a need for an apparatus that enables a pet owner to carry multiple articles and lead an animal without stressing the hand. Further, there is a need for such apparatus that enables a user to steer the animal, to adjust a length of the lead, and permits multiple leads to be used simultaneously. Still further, there is a need for such apparatus to permit the animal lead to be selectively separated from the user for temporarily attaching the animal to a stationary object when entering a store or the like. There is also a need for apparatus allowing the lead to be used separately as a leash, as well as, for apparatus that allow the lead to be selectively separated from the user in a panic or emergency situation.

### SUMMARY

In one aspect, apparatus for leading an animal comprises a belt sized for encircling a user's hips. The belt has a closure for selectively joining longitudinally spaced portions of the belt to hold the belt in position around the user's hips with an upper edge facing upward. The apparatus includes an anchor connected to a pack adjacent the upper edge of the belt. The anchor spans a predetermined longitudinal distance along the pack. The apparatus has a connector slidably mounted on the anchor for connecting an animal lead to the belt such that an upper end of the lead is selectively positionable along the anchor for guiding the animal circumferentially relative to the user.

In another aspect, the apparatus comprises a belt sized for encircling a user's hips. The belt has a closure for selectively joining longitudinally spaced portions of the belt to hold the belt in position around the user's hips. Further, the apparatus includes a pack having a back attached to the belt and a top adjacent the upper edge of the belt. The apparatus also comprises an anchor having opposite ends connected to the pack. The anchor is positionable across the top of the pack. The anchor ends are spaced by a predetermined distance extending parallel to the back of the pack. In addition, the apparatus has a connector slidably mounted on the anchor for connecting an animal lead to the pack such that an upper end of the lead is selectively positionable along the anchor for guiding the animal circumferentially relative to the user.

In yet another aspect, apparatus for dispensing waste recovery bags from a strip of frangibly connected waste recovery bags rolled on a spool having a hole extending longitudinally through the spool is disclosed. The apparatus comprises a pack having an interior sized and shaped for receiving the strip of frangibly connected waste recovery bags rolled on the spool and an entrance extending into the interior. The pack has an opening sized and shaped for passing the frangibly connected bags when unrolled from the spool to an exterior of the pack. In addition, the apparatus includes a mount having a base attached to the pack. The mount includes a spindle extending upward from the base into the interior of the pack. The spindle is sized and shaped for engaging the hole in the spool and allowing the spool to be selectively rotated on the spindle about a longitudinal axis of the spool to unroll the frangibly connected bags from the rolled strip.

Further, in another aspect the disclosure includes a lead system for leading an animal. The lead system comprises a plurality of tethers. Each tether includes an upper end and a lower end opposite said upper end, a female element having an opening adjacent the upper end, and a male element adapted for selective attachment to the female element adjacent the lower end. The tethers are selectively connectable in differing configurations by joining the male element of one of the tethers to the female element of another of the tethers.

In still another aspect, the disclosure includes a connector system for use with an elongate belt to provide one or more anchor points on the belt. The belt has a length sized for surrounding a user. The connector system comprises a mount having an outer opening providing the anchor point and an inner opening sized and shaped for slidably receiving the belt. The system also includes a keeper adapted for engaging an inner end of the mount. The keeper has a first receiver opening positioned on a first side of the mount when the mount engages the keeper and a second receiver opening positioned on a second side of the mount opposite the first side when the mount engages keeper. The first and second receiver openings are sized and shaped for slidably receiving the belt therein so the belt passes outward through the first receiver opening, across the mount through inner opening of the mount, and inward through the second receiver opening. When the belt is tensioned, friction between the belt and the keeper prevents the mount from sliding along the belt, and when tension is released, friction is reduced allowing the mount to slide along the belt.

Moreover, the apparatus comprises a belt sized for encircling a user's hips. The belt has a closure for selectively joining longitudinally spaced portions of the belt to hold the belt in position around the user's hips with an upper edge facing upward. The apparatus includes a pack having a back attached to the belt and a top adjacent the upper edge of the belt. Further, the apparatus comprises an anchor having opposite ends connected to the pack and extending across the top of the pack. The apparatus includes an animal lead having an upper end and a lower end opposite the upper end adapted for connection to an animal. In addition, the apparatus includes a connector having an upper portion adapted for connection to the anchor and a lower portion including a selectively releasable link having a closed position in which the link retains the upper end of the animal lead and an open position in which the link releases the upper end of the animal lead. The link includes a release that when actuated permits the link to move from the closed position to the open position thereby releasing the lead to prevent the animal from pulling the user.

In a further aspect, the connector connects an element to an anchor. The connector comprises a clip for connection to the anchor and a selectively releasable link. The link has a retainer moveable between closed position in which the retainer retains the element and an open position in which the retainer releases the element. The link includes a release that when actuated permits the retainer to move from the closed position to the open position thereby releasing the element from the anchor.

Other aspects of the present invention will be apparent in view of the following description and claims.

### BRIEF DESCRIPTION OF THE DRAWINGS

FIG. 1A is a perspective of apparatus for leading an animal.

FIG. 1B is a perspective of apparatus of an alternative embodiment.

FIG. 2 is an outer elevation of a belt of the apparatus of FIG. 1A.

FIG. 3 is a bottom plan of the belt.

FIG. 4 is a perspective of a pack of the apparatus of FIG. 1A.

FIG. 5 is a left side elevation of the pack.

FIG. 6 is a section of the pack taken in the plane of line 6-6 of FIG. 5.

FIG. 7 is a perspective of a pack of an alternative embodiment.

FIG. 8 is a section similar to FIG. 6 of the pack of FIG. 7.

FIG. 9 is a perspective of prior art animal waste recovery bags rolled on a spool.

FIG. 10 is a perspective of apparatus for dispensing waste recovery bags from the pack of FIG. 4.

FIG. 11 is a bottom view of the pack of FIG. 4.

FIG. 12 is a perspective of various animal leads or leashes.

FIG. 13 is a detail of a tether of a lead of FIG. 12.

FIG. 14 is a side elevation of a connector.

FIG. 15 is a top plan of the connector.

FIG. 16 is a section taken in the plane of line 16-16 of FIG. 15.

FIG. 17 is a section similar to FIG. 16 but showing a retainer in a released position.

Corresponding reference characters indicate corresponding parts throughout the drawings.

### DETAILED DESCRIPTION OF THE DRAWINGS

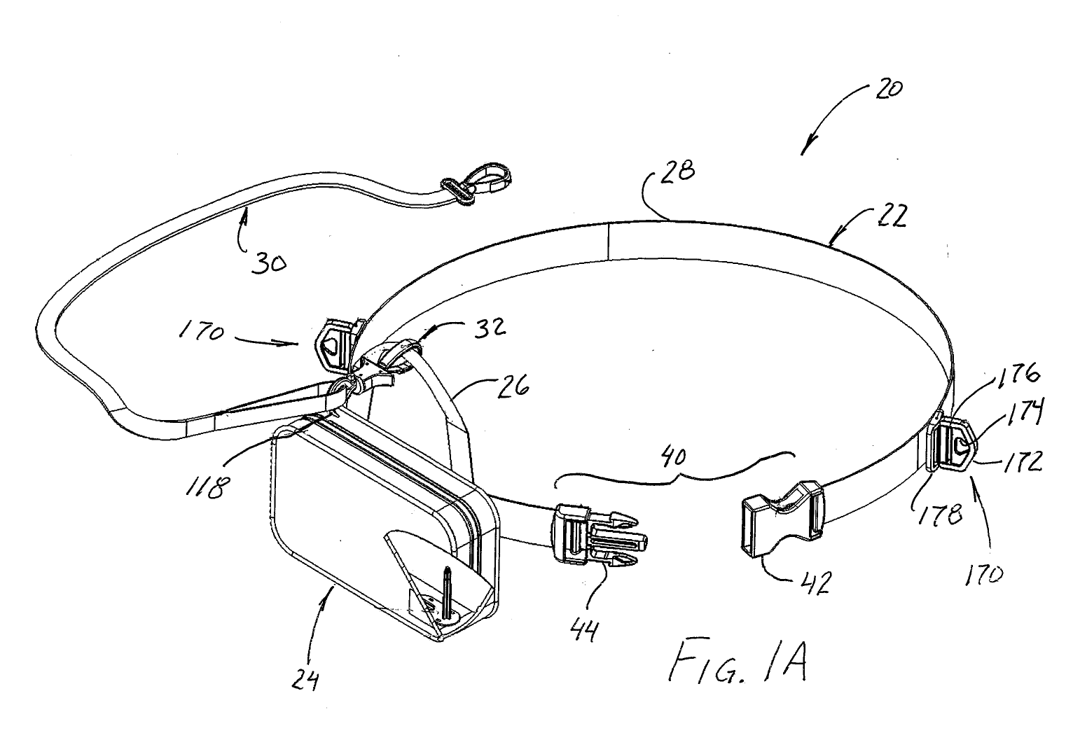

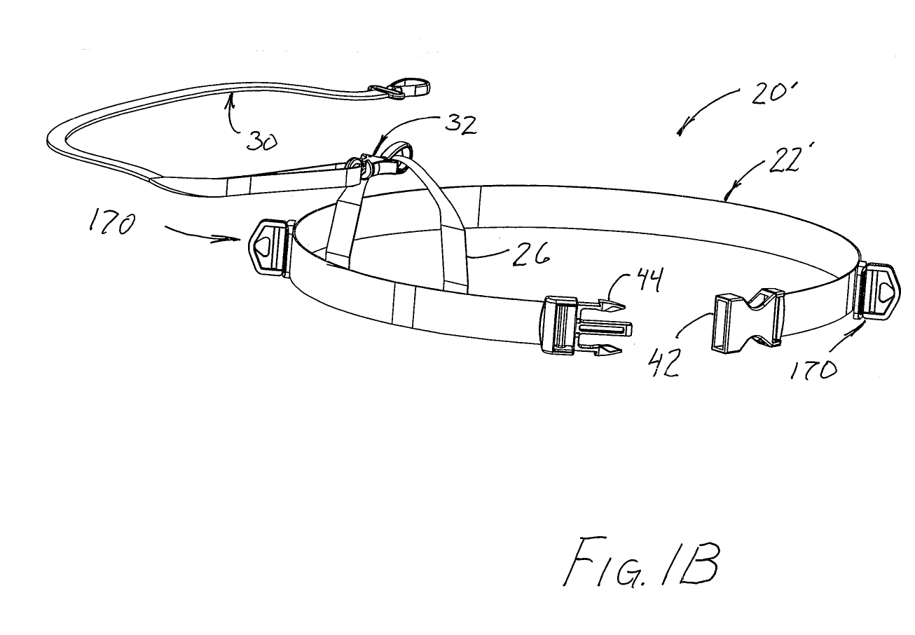

Referring to FIG. 1A, apparatus for leading an animal incorporating a first embodiment of the present invention is designated in its entirety by the reference number 20. The apparatus 20 includes a belt (generally designated by 22), a pack (generally designated by 24) connected to the belt, and an anchor 26 connected adjacent an upper edge 28 of the belt. An animal lead, generally designated by 30, is connected to the anchor 26 with a connector, generally designated by 32, for leading an animal.

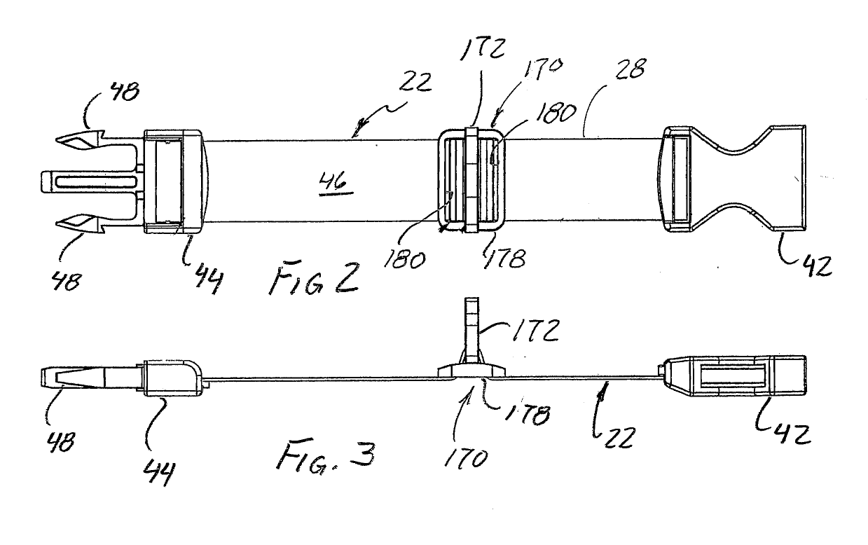

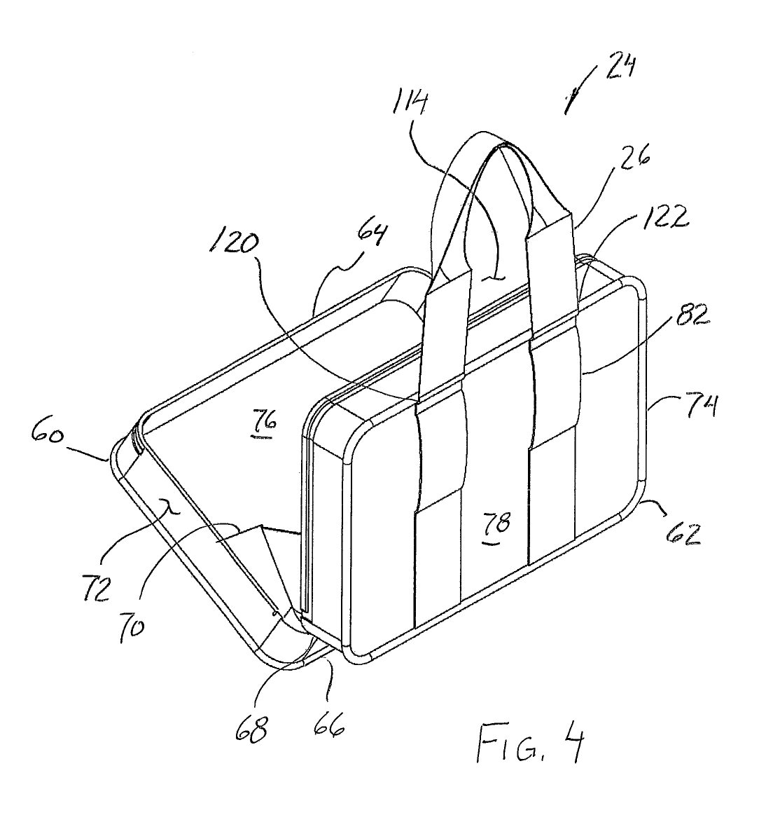

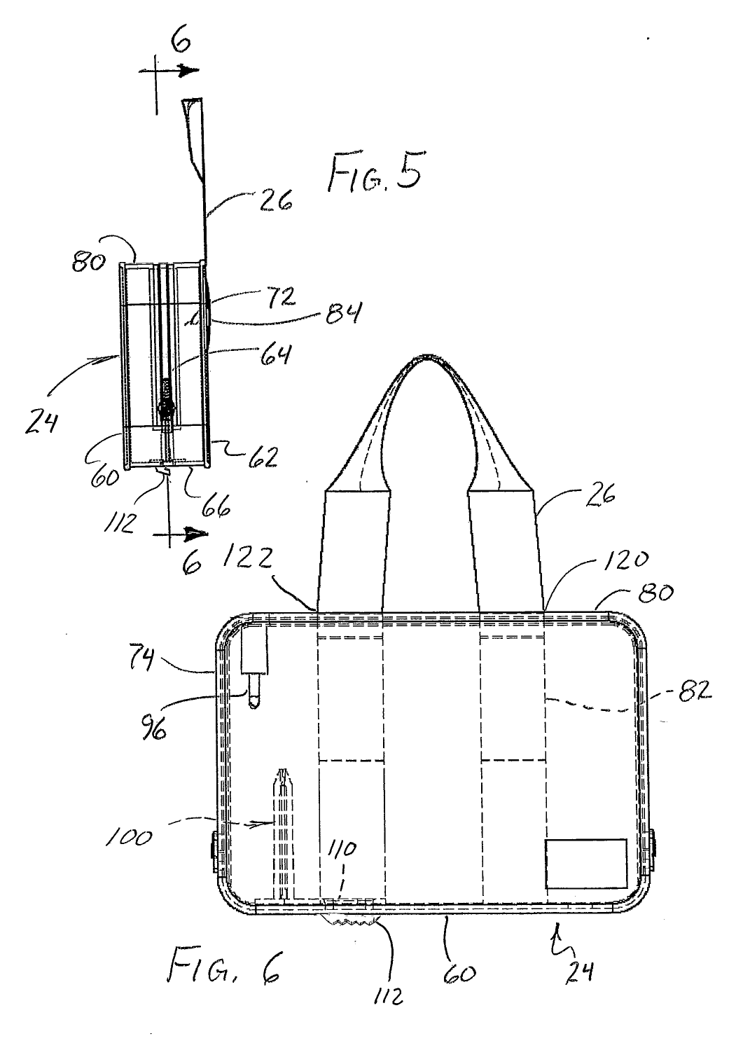

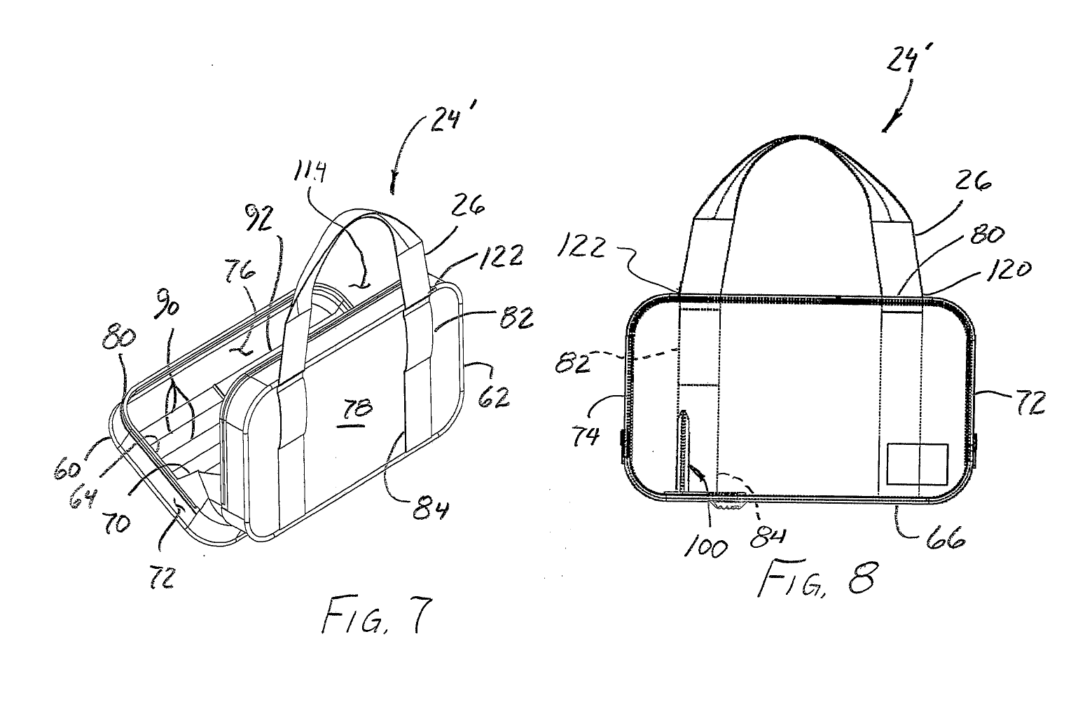

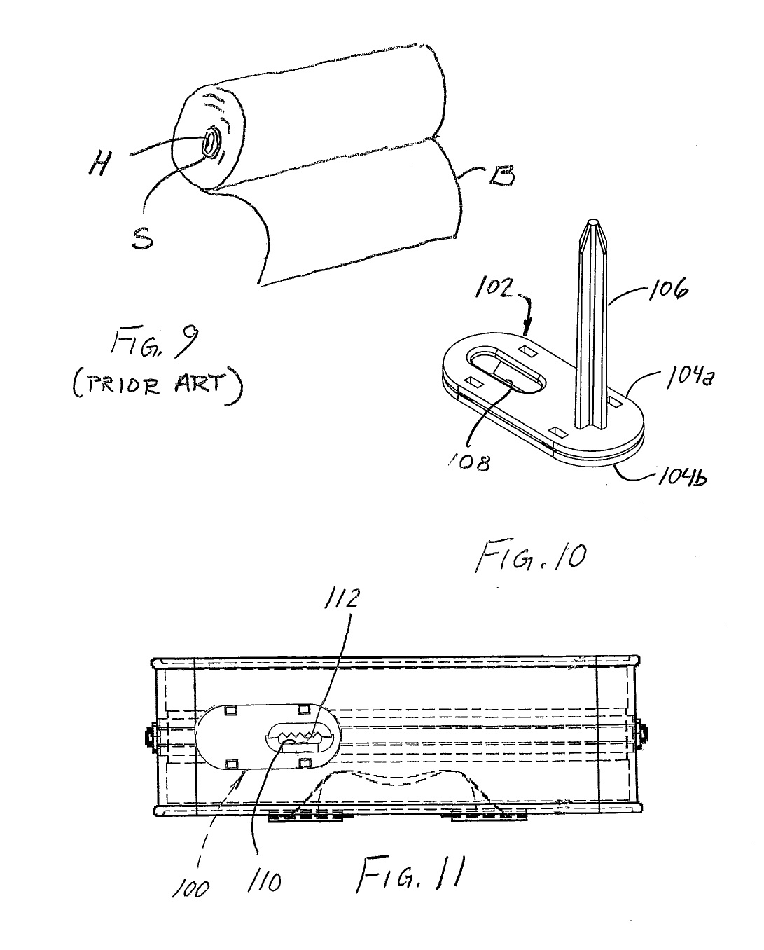

As illustrated in FIGS. 2 and 3, the belt 22 is sized for encircling a user's hips. The belt 22 has a closure 40 (FIG. 1A) including two clasps 42, 44 that are fixed at longitudinally spaced positions along the belt and selectively joinable to hold the belt in position around the user's hips with the upper edge 28 facing upward. Although fixed in position in use, at least one of the clasps (e.g., clasp 44) is movable along the belt 22 when not in use to change the length of the belt. In one embodiment, the belt is formed from 1½ inch wide webbing 46 having a female clasp 42 sewn onto one end and a complementary male clasp 44 having opposing hooks 48 adapted for insertion into the female clasp to selectively join the clasps and hold the webbing around the user's hips. The webbing 46 is looped through the male clasp 44 in a conventional manner so the clasp remains fixed in position on the webbing during use, but the clasp may be selectively repositioned for resizing the belt 22 for use by those having different hip dimensions. As will be appreciated by those skilled in the art, conventional extenders (not shown) may be used to increase the length of the belt beyond common sizes. Such extenders include a length of webbing with clasps 42, 44 at opposite ends. An exterior surface of the belt 22 may include reflectors or be reflective for increasing visibility of the user at night.

As shown in FIGS. 4-6, the pack 24 includes generally rectangular fabric shell portions 60, 62 having a zipper closure 64. In one embodiment, the zipper closure 64 comprises a double zipper. Further, the shell portions 60, 62 are joined along a bottom 66 of the pack of 24, forming a hinge 68 that allows the forward shell portion 60 to pivot open relative to the rearward portion 62 as shown in FIG. 4. Gusset panels 70 adjacent the hinge 68 and extend up the opposite left and right sides 72, 74 of the pack 24 limit the amount the forward shell portion 60 pivots away from the rearward portion 62 to prevent loss of articles from an interior 76 of the pack 24. The anchor 26 extends upward from a top of the rearward face 78 of the rearward portion 62 of the pack 24. The anchor 26 extends over the top of the pack 24 in use. Loops 82 are formed on the rearward face 78 of the pack 24 adjacent its top 80 for receiving the belt 22. Thus, when the belt 22 is threaded through the loops 82, the anchor 26 extends from the pack 24 adjacent the upper edge 28 of the belt. Thus, the pack 24 is selectively removable from the belt 22 for use separate from the belt. In one embodiment, a length of one inch wide webbing 84 is stitched to the rearward face 78 of the pack 24, forming the loops 82 and the anchor 26 as shown. Part of the webbing 84 is folded upon itself lengthwise and sewn together to improve the anchor 26 dimensions for accepting the animal lead 30.

Interior faces of the pack 24 may be partitioned. For example, in an alternative embodiment shown in FIGS. 7 and 8, one face (e.g., a forward face) of the interior 76 is partitioned for credit cards 90 and/or for a general-purpose pouch or pocket 92. In addition, the pocket 92 may include a closure such as a zipper (not shown) to retain articles (e.g., ear buds and phone) in the pocket. The pocket 92 may be made of any suitable material including netting, liner material, or clear plastic. Further, a key ring clip 96 extends downward from the top 80 of the pack 24 for holding a key ring (not shown). Although the pack 24 may be made of other materials without departing from the scope of the present invention, in one embodiment the pack is made from flexible, water repellent fabric, such as nylon.

As illustrated in FIG. 6, the pack 24 includes apparatus, generally designated by 100, for dispensing waste recovery bags B (FIG. 10), such as a conventional strip of frangibly connected bags rolled on a spool S. The spool S includes a hole H, extending longitudinally through the spool along its central axis. As further shown in FIG. 10, the apparatus 100 consists of a mount, generally designated by 102, having a two-piece base 104a, 104b attached to the bottom 66 of the pack 24. The mount 102 includes a spindle 106 extending from the base 104a. The spindle 106 positioned in the pack 24 and sized for holding a roll of waste collection bags B. The spindle 106 is adapted for extending into the hole H in the spool S to hold the spool upright and allow it to be selectively rotated on the spindle to unroll the strip of bags B. The bases 104a, 104b include an opening 108 adjacent the spindle 106. A loose end of the strip of bags B passes through the opening 108 and out the bottom 66 of the pack 24 through a corresponding opening 110 in the pack shown in FIG. 6.

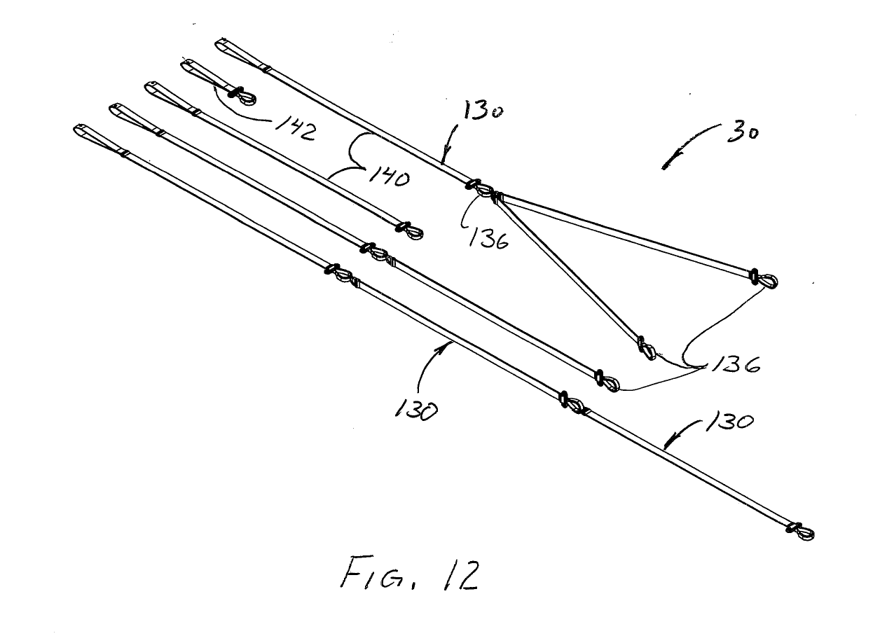

As shown in FIG. 11, a serrated cutter 112 is positioned in the opening 110 to aid in tearing a bag B from the roll. The cutter 112 also retains the unused bags B in the pack. A user may pull downward and forward on the exposed bag B to separate the bag from the strip. The separated bag may be used to collect animal waste. The bases 104a, 104b sandwich the bottom 66 of the pack 24 to join the mount 102 to the pack (e.g., with adhesives or mechanical fasteners) so the opening 108 in the base is aligned with the opening 110 (FIG. 6) in the pack. As will be appreciated by those skilled in the art, when fully opened as shown in FIG. 4, the pack 24 has a large entrance 114 extending upward from the bottom 66 of the pack along the left side 72 of the pack, across a top 80 of the pack, and downward the right side 74 of the pack to the bottom. Likewise, the interior 76 is sized and shaped for receiving the strip of frangibly connected waste recovery bags B rolled on the spool S. As shown in FIG. 1A, an opening 118 is provided in the top of the pack 24. The opening 118 is sized for passing ear bud wires connected to a phone or audio player in the interior 76 of the pack 24 so they may be used without opening the pack.

In an alternative embodiment, a separate waste bag holder may be used with the system. This alternative holder may be a container sized for holding bags B and having a clip for clipping the container on a leash or the like. The container will have an opening through which bags may be pulled, as well as, an opening aligned with the hole H. The spindle 106 will be inserted in the opening aligned with the hole H. A bag B pulled through the other opening may be threaded through the opening 110 in the pack 24.

Although the anchor 26 may take other forms without departing from the scope of the present invention, in one embodiment the anchor is an elongate band having opposite ends 120, 122 spaced along the pack 24 as shown in FIG. 4. The anchor 26 spans a predetermined longitudinal distance along the pack 24. Although the predetermined longitudinal distance may have other lengths without departing from the present invention, in one embodiment the distance is no less than about four inches. In the illustrated embodiment (e.g., FIG. 1A), the anchor 26 may be attached to the pack 24 and the pack attached to the belt 22 so the spaced ends 120, 122 are positioned adjacent the upper edge 28 of the belt so the anchor is indirectly connected to the belt by way of the pack. It is envisioned that the anchor 26 may be connected directly to the belt 22 adjacent its upper edge 28 in some embodiments as shown in FIG. 1B.

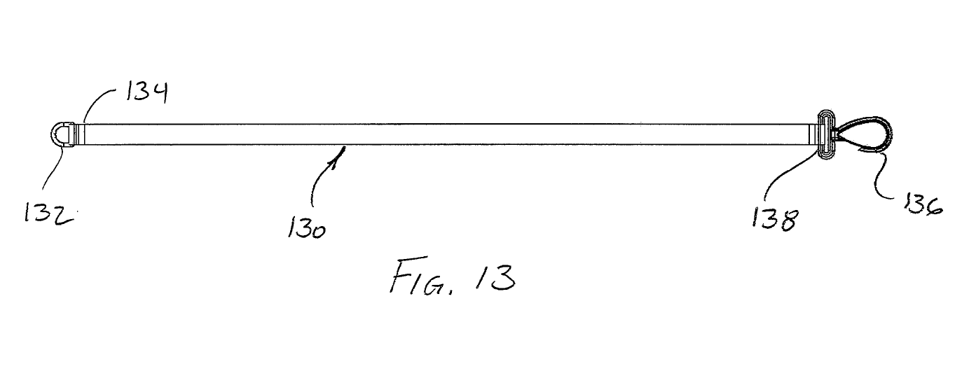

As illustrated in FIG. 12, various animal leads 30 comprise tethers or leashes, generally designated by 130, selectively joinable in series to adjust the length of the lead. As further shown in FIG. 13, each tether 130 has a ring 132 (broadly, a female element having an opening therein) at its upper end 134 and a conventional clasp 136 (broadly, a male element adapted for selective attachment to the female element) at its lower end 138. Although the tethers 130 may be made of other materials without departing from the scope of the present invention, in one embodiment each tether is formed from paracord. In some embodiments, each ring 132 is a plastic or metal ring, and each clasp 136 is a plastic or metal clip having a spring-loaded latch that blocks a gap of the hook. The latch is moveable against the spring loading to unblock the gap, permitting a ring to pass through the gap. Although each tether 130 may have other lengths without departing from the scope of the present invention, in one embodiment the tethers are provided in two foot lengths. As will be appreciated by those skilled in the art, any suitable length may be used. Thus, the animal lead 30 may be as short as two feet for attaching an animal to the apparatus 20 when running or in traffic. Tethers 130 of various lengths may be connected end-to-end to form an animal lead 30 of desired length as shown in FIG. 11. For example, a two foot tether 130 may be joined to a second two foot tether, forming a four foot animal lead 30 for attaching an animal to the apparatus 20 when walking. Additional tethers may be added at the discretion of the user. Further, the rings 132 and clasps 136 are sized so that a clasp is simultaneously attachable to more than one ring, creating a Y-shaped lead for leading a second animal. As further illustrated in FIG. 12, a grip 140 having length of a tether and a clasp 136 at a lower end may be joined to the ring 132 of a tether 130 to form a leash when the tether is disconnected from the apparatus 20. In one alternative, a handle 142 having a clasp 136 may be joined to the ring 132 of a tether 130 to form a leash when the tether is disconnected from the apparatus 20. Thus, the tether may be used separately from the system 20 as a leash.

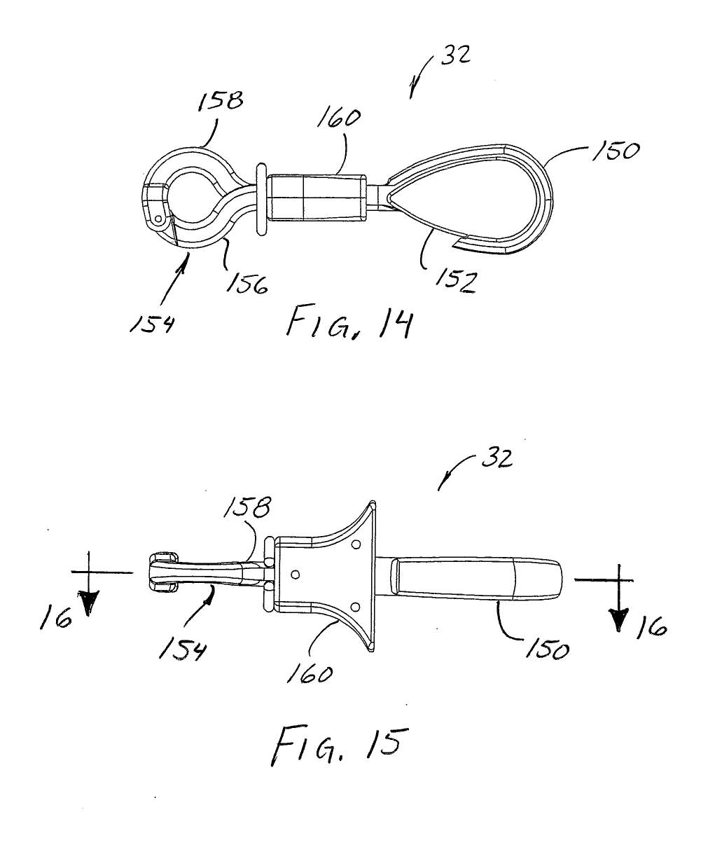

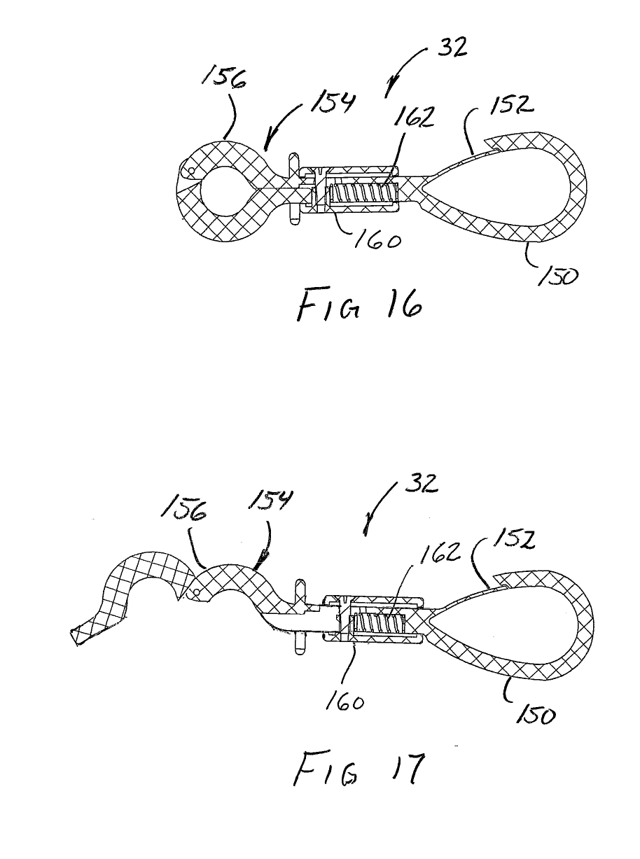

The connector 32 is slidably mounted on the anchor 26 for connecting the animal lead 30 to the pack 24. The lead 30 is selectively positionable along the anchor for guiding the animal. For example, the user may move the connector 32 left on the anchor 26 to guide the animal toward the left. An upper end of the lead is selectively positionable along the anchor for guiding the animal laterally or circumferentially relative to the user. Although other connectors (e.g., carabiners) may be used without departing from the scope of the present invention, in an embodiment illustrated in FIGS. 14-16, the connector 32 includes a clip 150 for connecting the connector to the anchor 26. In one embodiment, the clip 150 includes an elastically deformable clasp 152 that retains the anchor 26 in the clip. The clasp 152 deforms to allow the anchor 26 to be inserted in the clip 150 and returns to its undeformed shape to prevent the anchor from separating from the clip. The connector 32 has a releasable link, generally designated by 154, opposite the clip 150. The link 154 includes main body 156 and a retainer 158 pivotally attached to the main body. The retainer 158 pivots between a closed position as shown in FIG. 16 and an open position as shown in FIG. 17. When in the closed position, the link 154 holds the upper end of the animal lead to connect the lead to the anchor. When in the open position, the retainer 158 releases the upper end of the lead, allowing the lead to separate from the anchor. As will be apparent to those skilled in the art, the retainer 158 encompasses more than 180° to ensure the lead separates from the connector 32 when the retainer is open. A release 160 is slidably mounted on the connector. When in the position shown in FIG. 16, the release 160 holds the retainer 158 in the closed position. A spring 162 is provided in the release 160 to hold the release in the position shown in FIG. 16. When the release 160 is pulled against the force of the spring 162 toward the clip 150, the release releases the retainer 158, permitting it to move to the open position shown in FIG. 17. In the event an animal pulls too hard on a user, the user can pull the release 160, allowing the lead to separate from the connector 32 to prevent the user from falling or being dragged. In some embodiments, a second connector (not shown) may be connected to the anchor 26 for leading two animals at once.

A supplemental or auxiliary connector system shown in FIGS. 1-3, generally designated by 170, may be used to connect a lead or other accessory to the belt 22. The connector system 170 includes a mount 172 having an outer opening 174 for receiving the lead or accessory. The mount 172 also has an inner opening or slot 176 sized and shaped for slidably receiving the belt 22. The system 170 also includes a keeper 178 that engages an inner end of the mount. The keeper 178 has receiver openings 180 positioned on opposite sides of the mount 172 that slidably receive the belt as shown so the belt passes outward through the one receiver opening, through inner opening of the mount, and inward through the other receiver opening. As will be appreciated by those skilled in the art, when the belt 22 fastened around a user the belt is in tension. Friction between the belt 22 and the keeper 178 prevents the mount 172 from sliding along the belt. However, when the belt 22 is removed from the user, tension is released. Friction is reduced, allowing the mount 172 to slide along the belt 22.

Various attachments may also be attached to the belt 22. Examples of these attachments include a tether for extending the lead, a waste recovery bag dispenser, a dog toy, exercise equipment, a pre-moistened towel container, a dog treat dispenser, a wallet, eyeglasses holder, an audio player, a poncho, an umbrella, a treat holder, a bottle holder, a bowl, and a bag.

Although the apparatus is described as being used with a particular lead system, those skilled in the art will appreciate that the apparatus may be used with a conventional leash.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. Apparatus for leading an animal, comprising:
a belt sized for encircling a user's hips, the belt having a closure for selectively joining longitudinally spaced portions of the belt to hold the belt in position around the user's hips with an upper edge facing upward;
an anchor connected to the belt adjacent the upper edge, the anchor spanning a predetermined longitudinal distance along the belt; and
a connector slidably mounted on the anchor for connecting an animal lead to the belt such that an upper end of the lead is selectively positionable along the anchor for guiding the animal laterally relative to the user.

2. Apparatus as set forth in claim 1, further comprising a second connector slidably mounted on the anchor for connecting a second animal lead to the belt.

3. Apparatus as set forth in claim 2, further comprising a mount selectively positionable along the belt for attaching a third connector to the belt for connecting a third animal lead to the belt.

4. Apparatus as set forth in claim 1, further comprising a pack attached to the belt.

5. Apparatus as set forth in claim 4, wherein the anchor is attached to the pack.

6. Apparatus as set forth in claim 4, wherein the pack is selectively removable from the belt.

7. Apparatus as set forth in claim 4, further comprising a mount positioned in the pack and sized for holding a roll of waste collection bags, and wherein the pack includes an opening adjacent the mount for dispensing waste collection bags from the pack.

8. Apparatus as set forth in claim 4, further comprising a cutter mounted in the opening adjacent the mount for separating bags being dispensed from the pack.

9. Apparatus as set forth in claim 1, further comprising a mount positioned in the pack and sized for holding a container holding a roll of waste collection bags, and wherein the pack includes an opening adjacent the mount for dispensing waste collection bags from the pack.

10. Apparatus as set forth in claim 1, further comprising an animal lead adapted for selective attachment to the connector.

11. Apparatus as set forth in claim 10, wherein the animal lead has a selectively adjustable length.

12. Apparatus as set forth in claim 11, wherein the length of the animal lead is adjustable to a minimum length of about two feet.

13. Apparatus as set forth in claim 10, wherein the animal lead comprises a plurality of tethers selectively joinable in series to adjust the length of the lead.

14. Apparatus as set forth in claim 1, wherein the predetermined longitudinal distance the anchor spans along the belt is at least about four inches.

15. Apparatus as set forth in claim 1, wherein the belt is adjustable for use by users having different hip dimensions.

16. Apparatus as set forth in claim 1, wherein the connector is selectively disconnectable from the anchor.

17. Apparatus as set forth in claim 1, further comprising an attachment attached to the belt, said attachment being selected from a group of attachments consisting of a tether for extending the lead, a waste recovery bag dispenser, a dog toy, exercise equipment, a pre-moistened towel container, a dog treat dispenser, a wallet, eyeglasses holder, an audio player, a poncho, an umbrella, a treat holder, a bottle holder, a bowl, and a bag.

18. Apparatus as set forth in claim 1, wherein the anchor is connected indirectly to the belt adjacent the upper edge.

19. Apparatus for leading an animal, comprising:
a belt sized for encircling a user's hips, the belt having a closure for selectively joining longitudinally spaced portions of the belt to hold the belt in position around the user's hips with an upper edge facing upward;
a pack having a back attached to the belt and a top adjacent the upper edge of the belt;
an anchor having opposite ends connected to the pack and extending across the top of the pack, the anchor ends being spaced by a predetermined distance extending parallel to the back of the pack; and
a connector slidably mounted on the anchor for connecting an animal lead to the pack such that an upper end of the lead is selectively positionable along the anchor for guiding the animal laterally relative to the user.

20. Apparatus as set forth in claim 19, further comprising a second connector slidably mounted on the anchor for connecting a second animal lead to the pack.

21. Apparatus as set forth in claim 19, further comprising a supplemental connector system connected to the belt for attaching a third connector to the belt for connecting a third animal lead to the belt.

22. Apparatus as set forth in claim 19, wherein the pack is selectively removable from the belt.

23. Apparatus as set forth in claim 22, further comprising a mount positioned in the pack and sized for holding a roll of waste collection bags, and wherein the pack includes an opening adjacent the mount for dispensing waste collection bags from the pack.

24. Apparatus as set forth in claim 22, further comprising a cutter mounted in the opening adjacent the mount for separating bags being dispensed from the pack.

25. Apparatus as set forth in claim 19, further comprising a mount positioned in the pack and sized for holding a container holding a roll of waste collection bags, and wherein the pack includes an opening adjacent the mount for dispensing waste collection bags from the pack.

26. Apparatus as set forth in claim 19, further comprising an animal lead adapted for selective attachment to the connector.

27. Apparatus as set forth in claim 26, wherein the animal lead has a selectively adjustable length.

28. Apparatus as set forth in claim 27, wherein the length of the animal lead is adjustable to a minimum length of about two feet.

29. Apparatus as set forth in claim 27, wherein the animal lead comprises a plurality of tethers selectively joinable in series to adjust the length of the lead.

30. Apparatus as set forth in claim 19, wherein the predetermined longitudinal distance by which the ends of the anchor are spaced is at least about four inches.

31. Apparatus as set forth in claim 19, wherein the belt is adjustable for use by users of different dimensions.

32. Apparatus as set forth in claim 19, wherein the connector is selectively disconnectable from the anchor.

33. Apparatus as set forth in claim 19, further comprising an attachment attached to the belt, said attachment being selected from a group of attachments consisting of a waste recovery bag dispenser, a dog toy, exercise equipment, a pre-moistened towel container, a dog treat dispenser, a wallet, eyeglasses holder, an audio player, a poncho, an umbrella, a treat holder, a bottle holder, and a bag.

34-54. (canceled)
